(19) United States
(12) Patent Application Publication
(10) Pub. No.: US 2026/0070799 A1
(43) Pub. Date: Mar. 12, 2026

(54) ORGANIC HEXACYANOFERRATES: SYNTHESES AND USES

(71) Applicant: WALKER CANCER RESEARCH INSTITUTE, INC., Boynton Beach, FL (US)

(72) Inventor: Eduardo PALOMINO, Troy, MI (US)

(73) Assignee: WALKER CANCER RESEARCH INSTITUTE, INC., Boynton Beach, FL (US)

(21) Appl. No.: 18/882,195

(22) Filed: Sep. 11, 2024

(51) Int. Cl. C01C 3/12

(52) U.S. Cl. CPC C01C 3/12

(57) ABSTRACT

The synthesis and uses of organic hexacyanoferrates is provided. The synthesis of organic hexacyanoferrates includes steps of reacting potassium ferrocyanide or potassium ferricyanide with a nitrogen-organic compound and then collecting the crystals formed therefrom. Compounds of the formula R₃Fe(CN)₆ are formed from potassium ferricyanide (K₃Fe(CN)₆), Compound of R₄Fe(CN)₆ are formed from potassium ferrocyanide (K₄Fe(CN)₆). Compounds of the formula R₃FeH(CN)₆, are formed by reacting R₃Fe(CN)₆ with hydrazine. Compounds of the formula R₃FeH(CN)₆ are formed from tri-potassium hydrogen ferrocyanide (K₃HFe(CN)₆).

### TECHNICAL FIELD

In at least one aspect, the present invention is related to the synthesis and application of organic hexacyanoferrates.

### BACKGROUND

Potassium hexacyanoferrates (II) and (III), known as potassium ferrocyanides and potassium ferricyanides, are among the oldest synthesized chemicals, dating back to 1752 and 1822, respectively. These compounds have a wide range of applications. Potassium ferrocyanide is used in the production of wine and citric acid, as an anticaking agent, fertilizer, and for the purification of tin. Potassium ferricyanide is utilized in hardening iron and steel, electroplating, dyeing wool, creating blueprints, and serving as an oxidizing agent in organic chemistry. Additionally, a notable application of potassium ferricyanide is in physiology, where it is used to study cytochromes from mitochondria by enhancing the redox potential of a solution. The redox potential of both potassium ferrocyanide and ferricyanide varies with the pH and composition of the solution in which they are dissolved. It is worth noting that there are no reports in the literature of organic ferrocyanides or ferricyanides, whether with or without hydrogen attached.

Accordingly, there is a need for variations of hexacyanoferrates.

### SUMMARY

In at least one aspect, a compound having formula 1 is provided:

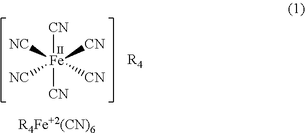

wherein R is a nitrogen-containing organic cation, and the oxidation state of iron is +2 (Fe⁺²).

In another aspect, a method for making the compound having formula 1 is provided. The method includes steps of mixing a salt of a nitrogen-containing organic compound, particularly the hydrochloride, thereof with potassium ferrocyanide (K₄Fe(CN)₆) in water and collecting crystals formed after a variable crystallization-induction time.

In another aspect, the compounds embodied by formula 1 can also be used clinically as a redox-based delivery agents of the ligand groups attached to them. The attached R groups may have inherent properties as anticancer nitrogen mustards, adenosine receptors inhibitors and general modulators that are released upon activation by an oxidant agent such as hydrogen peroxide or the hydroxyl radical inside the body.

In another aspect, a compound having formula 2 is provided:

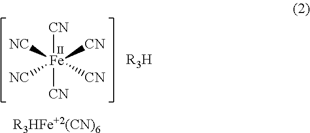

wherein R is a nitrogen-containing organic cation, and the oxidation state of iron is +2 (Fe⁺²).

In another aspect, a method for making the compound having formula 2 is provided. The method includes steps of mixing a compound having formula R₃Fe(CN)₆ in water with hydrazine; and collecting crystals formed after a variable crystallization-induction time.

In another aspect, a method for making the compound having formula 2 is provided. The method includes steps of mixing a salt of a nitrogen-containing organic compound, particularly the hydrochloride, thereof with tri-potassium hydrogen ferrocyanide (K₃HFe(CN)₆) in water and collecting crystals formed after a variable crystallization-induction time.

In another aspect, a new method for making the compound tri-potassium hydrogen ferrocyanide (K₃HFe(CN)₆) is provided. The new method includes steps of mixing a compound having formula K₃Fe(CN)₆ in water with hydrazine and collecting the solid formed after concentration via filtration.

In another aspect, a method for preparing an organic hydrogen ferrocyanide is provided. The method includes a step of reacting tri-potassium hydrogen ferrocyanide (K₃HFe(CN)₆) with an amine hydrochloride RCl, where R is a nitrogen-containing organic cation of a primary amine, a secondary amine, or a tertiary amine, to form compound 2:

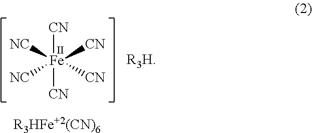

In another aspect, the compounds embodied by formula 2, in addition to being used as oxidants, are effective clean hydroxyl radical generators, more effective than the indiscriminate Fenton compounds in current use.

In another aspect, a compound having formula 3 is provided:

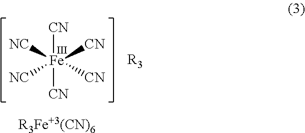

wherein R is a nitrogen-containing organic cation, and the oxidation state of iron is +3 (Fe⁺³).

In another aspect, a method for making the compound having formula 3 is provided. The method includes steps of mixing a salt of a nitrogen-containing organic compound, particularly the hydrochloride, thereof with potassium ferricyanide (K₃Fe(CN)₆) in water and collecting crystals formed after a variable crystallization-induction time.

In another aspect, the syntheses of compounds of structural formulas 1, 2, and 3 are provided:

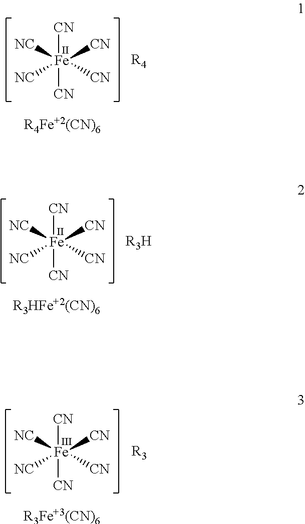

wherein R is a nitrogen-containing organic compound such as amine, imidazole, purine, pyridine, catecholamine, amino acid, etc. R can be referred to as a ligand. Structures 1 and 2 share the same oxidation state of iron (Fe⁺²), which is referred to by the names of ferrocyanide or hexacyanoferrate II, and structure 3 contains Fe⁺³ which is referred to as ferricyanide or hexacyanoferrate III. Although structures 1 and 2 have the same oxidation state of iron, the inclusion of a ligand hydrogen (H) in 2 endows the structure with the ability of changing to structure 3 by reaction with hydrogen peroxide (H₂O₂), releasing in the process hydroxyl radicals (HO⁻), important intermediates in many biological reactions. Structure 1, on the other hand, also reacts with H₂O₂ to produce structure 3 ejecting in the process a unit of a ligand modified by reaction with the hydroxyl radical.

In another aspect, the compounds set forth herein can be used as general oxidant or reducing agents and in all other processes in which the inorganic counterparts are used with the extra benefit of being soluble in many organic solvents, a fact that expands the use in a multitude of settings.

In another aspect, the compounds of the present disclosure have variations in the oxidation and reduction potentials based on the ligand attached, much like cytochromes have in the respiratory chain in animals. That variation can be used to tailor-made the oxidation or reduction value to a particular application without modifying the pH or composition of the solution they are in.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a further understanding of the nature, objects, and advantages of the present disclosure, reference should be had to the following detailed description, read in conjunction with the following drawings, wherein like reference numerals denote like elements and wherein:

FIGS. 1a, 1b, and 1c. General reaction for the synthesis of Amine Hydrochlorides (1a), Organic Ferricyanides (1b), and Organic Ferrocyanides (1c).

FIG. 2. General reaction for the synthesis of Organic Hydrogen Ferrocyanides.

FIGS. 3a and 3b. General reaction of Organic Hydrogen Ferrocyanides with hydrogen peroxides to produce hydroxyl radicals (3a) and detection of hydroxyl radicals using 2-amino phenol (3b).

FIG. 4. General reaction of Organic Ferrocyanides with hydrogen peroxide.

FIG. 5. Crystal structure of tris (2-methyl benzimidazole) ferricyanide.

FIG. 6. Crystal structure of tetra imidazole ferrocyanide.

FIG. 7. Crystal structure of tetra caffeine ferrocyanide.

FIG. 8. Crystal structure of tetra (4-aminophenol) ferrocyanide.

### DETAILED DESCRIPTION

Reference will now be made in detail to presently preferred compositions, embodiments and methods of the present invention, which constitute the best modes of practicing the invention presently known to the inventors. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g., pressure, pH, etc.) can be practiced with plus or minus 50 percent of the values indicated rounded to three significant figures. In a refinement, concentrations, temperature, and reaction conditions (e.g., pressure, pH, etc.) can be practiced with plus or minus 30 percent of the values indicated rounded to three significant figures of the value provided in the examples. In another refinement, concentrations, temperature, and reaction conditions (e.g., pH, etc.) can be practiced with plus or minus 10 percent of the values indicated rounded to three significant figures of the value provided in the examples.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

The term “amine,” as used herein, refers to an organic compound derived from ammonia (NH₃) by replacing one, two, or all three of the hydrogen atoms with alkyl or aryl groups (e.g., C1-10 alkyl groups). Therefore, amines include primary amines, secondary amines, or tertiary amines. In a refinement, the amines have the formula R¹NH₂ or R¹R²NH, or R¹R²R³N where R¹, R², and R³ are C₁₋₁₀ alkyl. Examples of primary amines include dopamine, histamine, and octopamine. Secondary amines include di-ethanol amine, di-isopropyl amine, and dibenzyl amine.

The term “imine” refers to an organic compound that contains a carbon-nitrogen double bond (C═N), where the nitrogen atom is bonded to a hydrogen atom or an organic group (alkyl or aryl). The general structure of an imine is R₁R₂C═NR₃, where R₁ and R₂ can be hydrogen atoms or organic groups (e.g. C₁₋₁₀ alkyl or C₆₋₁₄ aryl), and R₃ is typically a hydrogen atom or an alkyl/aryl group (e.g. C₁₋₁₀ alkyl or C₆₋₁₄ aryl).

The term “amide” refers to a functional group in organic chemistry characterized by the structure —C(═O)NR₂, where C(═O) represents a carbonyl group (a carbon atom double-bonded to an oxygen atom) and NR₂ represents a nitrogen atom bonded to two other substituents, which can be hydrogen atoms, alkyl groups (e.g. C₁₋₁₀ alkyl), or aryl group (e.g., C₆₋₁₄ aryl).

The term “room temperature” refers to temperatures of 20° C. to 25° C.

Unless stated to the contrary, reactions set forth herein can be conducted at temperatures from 20° C. to 30° C., and in particular, at room temperature and at pressures of about 1 atmosphere.

Typically, the reactions are carried out at ambient temperatures and pressure. For example, the reaction can be carried out at a temperature from 20 to 30° C. (e.g. room temperature) and a pressure of about 0.8 to 1.2 atm. It should be appreciated that the hypochlorite salts used in each of the methods can be replaced with other hypohalite salts such as potassium hypoiodite.

In at least one aspect, the syntheses of organic hexacyanoferrates II and III, also known as organic ferro- and ferricyanides, in which the organic part of the molecules is composed of compounds containing a nitrogen atom in the structure is provided. Although the inorganic ferro and ferricyanides, particularly those of potassium, have been known and used for over 200 years, no organic counterparts exist in the literature. To produce an organic ferro- or ferricyanide, the organic ligand must exist as a salt, particularly a hydrochloride salt and, to that effect, amines are the compounds of choice. The methodology is called a Salt Exchange, in which the laws controlling the strength of the final compounds dictate the outcome. In this regard, potassium ferricyanide K₃[Fe(CN)₆] or potassium ferrocyanide K₄[Fe(CN)₆], for example, are considered salts of weak acids (ferricyanic and ferrocyanic acids) with the strong base potassium hydroxide. For a salt exchange to occur, another salt in which its components are reversed in strength compared to the potassium ferri- and ferrocyanides must be used. Primary, secondary, and tertiary amine hydrochlorides are the most easily available reagents that can be prepared in situ using amines and hydrochloric acid, as shown in FIG. 1a for a primary amine. The stoichiometry of the reaction of the amine hydrochloride with potassium ferricyanide follows the composition of the starting material, so 3 moles of the amine hydrochloride should be used per mole of ferricyanide (FIG. 1b) and 4 moles of the amine should be used per mole of the ferrocyanide, as shown in FIG. 1c.

In another aspect, the synthesis of organic hydrogen-hexacyanoferrates II of the general formula R₃HFe(CN)₆, also known as organic hydrogen ferrocyanide is provided. The method includes steps of mixing a salt of a nitrogen-containing organic compound, particularly the hydrochloride, thereof with tri-potassium hydrogen ferrocyanide (K₃HFe(CN)₆) in water and collecting crystals formed after a variable crystallization-induction time.

In another aspect, a new method for making the compound tri-potassium hydrogen ferrocyanide (K₃HFe(CN)₆) is provided. The new method includes steps of mixing a compound having formula K₃Fe(CN)₆ in water with hydrazine and collecting the solid formed after concentration via filtration.

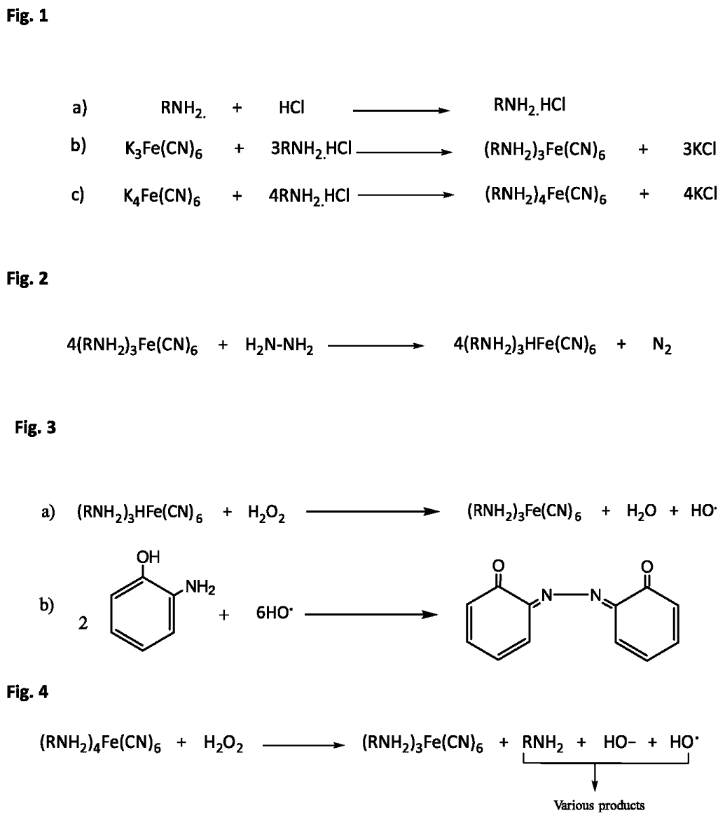

In another aspect, another synthesis of organic hydrogen-hexacyanoferrates II, also known as organic hydrogen ferrocyanide is provided. These organic hydrogen-hexacyanoferrates II of the general formula R₃HFe(CN)₆ is prepared by reduction of the corresponding organic hexacyanoferrate III, R3Fe(CN)₆ with hydrazine, H₂N—NH₂. The reaction, as shown in FIG. 2, is a green reaction that produces nitrogen gas, N₂, as the only by-product.

In another aspect, the organic hydrogen-hexacyanoferrates II have the ability of producing clean hydroxyl radicals (HO⁻) upon reacting with hydrogen peroxide (H₂O₂), a property that makes them especially useful as a clean replacement to the Fenton reaction in which the hydroxyl radicals are produced alongside a host of other radicals. That reaction is shown in FIG. 3a. The hydroxyl radicals produced can be used as reagent for several useful sequential diradical reactions such as the one shown in FIG. 3b where 2-aminophenol is converted to 2-iminoquinone by simply exposing the aminophenol to the freshly generated hydroxyl radicals.

In another aspect, other important reactions that can be performed in one step using the hydroxyl radical generated are the conversion of α-tocopherol (the most common form of vit. E) to the anti-platelet E-quinone, hydroquinone to p-benzoquinone, ascorbic acid to dehydroascorbic acid, p-aminophenol to p-iminoquinone, etc.

In another aspect, the organic ferrocyanides, or hexacyanoferrates II, also display a useful reaction with hydrogen peroxide (H₂O₂), equivalent to the Fenton reaction (FIG. 4), in which the iron, in oxidation state +2 (Fe⁺²), gets oxidized to Fe⁺³ by donating an electron to H₂O₂ that splits producing a hydroxyl radical (HO⁻) and a hydroxide anion (HO⁻). In addition, a ligand is modified by the hydroxyl radical and/or the hydroxide anion and released. The ligand can be selected that when released as a modified molecule can have useful applications, such as anticancer, antiviral, antibacterial, etc.

In another aspect, an organic hexacyanoferrates II having formula 1 is provided:

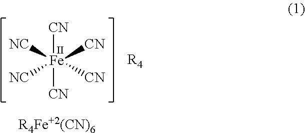

wherein R is a nitrogen-containing organic cation, and the oxidation state of iron is +2 (Fe⁺²). Sometimes, R is referred to as a ligand. In a refinement, R is a nitrogen-containing organic cation of an amine, an imine, an amide, or a nitrogen-containing polycyclic compound. In another refinement, R is a nitrogen-containing organic cation of primary amine, a secondary amine, a tertiary amine, imidazolyl, purinyl, pyridyl, catecholaminyl, or aminoacyl. Therefore, R can be a nitrogen-containing organic cation of an amine selected from R¹NH₂, R¹R²NH, or R¹R²R³N where R¹, R², and R³ are C₁₋₁₀ alkyl. In another refinement, R is a nitrogen-containing organic cation of dopamine, histamine, octopamine, di-ethanol amine, di-isopropyl amine, dibenzyl amine, imidazole, benzimidazole, and caffeine.

In another aspect, a method for making the compound having formula 1 is provided. The method includes steps of mixing a salt of a nitrogen-containing organic compound thereof with potassium ferrocyanide (K₄Fe(CN)₆) in water and collecting crystals formed after a variable crystallization-induction time. In a refinement, the salt of a nitrogen-containing organic compound is a salt (e.g., the hydrochloride) of an amine, an imine, an amide, or a nitrogen-containing polycyclic compound. In another refinement, the salt of a nitrogen-containing organic compound is a salt (e.g., the hydrochloride) of a primary amine, a secondary amine, a tertiary amine, imidazole, purine, pyridine, a catecholamine, or an amino acid. Therefore, the salt of a nitrogen-containing organic compound can be the salt of an amine selected from R¹NH₂, R¹R²NH or R¹R²R³N where R¹, R², and R³ are C₁₋₁₀ alkyl. In a refinement, about 4 mole equivalents of the salt of a nitrogen-containing organic compound thereof are mixed with 1 mole of potassium ferricyanide. In some refinements, the molar ratio of the salt of a nitrogen-containing organic compound thereof to potassium ferricyanide is at least 2:1, 3:1, 4:1, and at most 8:1, 7:1, 6:1, 5:1, or 4:1.

In another aspect, a compound having formula 2 is provided:

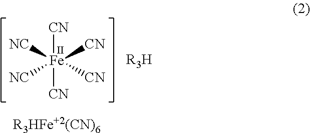

wherein R is a nitrogen-containing organic cation, and the oxidation state of iron is +2 (Fe⁺²). Sometimes, R is referred to as a ligand. In a refinement, R is a nitrogen-containing organic cation of an amine, an imine, an amide, or a nitrogen-containing polycyclic compound. In another refinement, R is a nitrogen-containing organic cation of a primary amine, a secondary amine, a tertiary amine, imidazolyl, purinyl, pyridyl, catecholaminyl, or aminoacyl. In this context, amino includes alkyl and diallyl amines. Therefore, R can be a nitrogen-containing organic cation of an amine selected from R¹NH₂ or R¹R²NH or R¹R²R³N where R¹, R², and R³ are C₁₋₁₀ alkyl. In another refinement, R is a nitrogen-containing organic cation of dopamine, histamine, octopamine, di-ethanol amine, di-isopropyl amine, dibenzyl amine, imidazole, benzimidazole, and caffeine.

In another aspect, a method for making the compound having formula 2 is provided. The method includes steps of mixing a compound having formula R₃Fe(CN)₆ in water with hydrazine and collecting crystals formed after a variable crystallization-induction time. In a refinement, about 1 mole equivalent of formula R₃Fe(CN)₆ is mixed with 1 mole of hydrazine. In some refinements, the molar ratio of formula R₃Fe(CN)₆ to hydrazine is at least 2:1, 3:1, 4:1 and at most 8:1, 7:1, 6:1, 5:1, or 4:1.

In another aspect, a method for making the compound having formula 2 is provided. The method includes steps of mixing a salt of a nitrogen-containing organic compound, particularly the hydrochloride, thereof with tri-potassium hydrogen ferrocyanide (K₃HFe(CN)₆) in water and collecting crystals formed after a variable crystallization-induction time.

In another aspect, a method for making the compound having formula K₃HFe(CN)₆) is provided. The new method includes steps of mixing a compound having formula K₃Fe(CN)₆ in water with hydrazine and collecting the solid formed after concentration via filtration.

In another aspect, an organic hexacyanoferrate compound having formula 3 is provided:

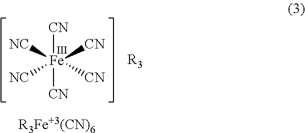

wherein R is a nitrogen-containing organic cation and the oxidation state of iron is +3 (Fe⁺³). Sometimes, R is referred to as a ligand. In a refinement, R is a nitrogen-containing organic cation of an amine, an imine, an amide, or a nitrogen-containing polycyclic compound. In another refinement, R is a nitrogen-containing organic cation of a primary amine, a secondary amine, a tertiary amine, imidazolyl, purinyl, pyridyl, catecholaminyl, or aminoacyl. In this context, amino includes alkyl and diallyl amines. Therefore, R a nitrogen-containing organic cation of an amine selected from R¹NH₂, R¹R²NH, or R¹R²R³N where R¹, R², and R³ are C₁₋₁₀ alkyl. In another refinement, R is a nitrogen-containing organic cation of dopamine, histamine, octopamine, di-ethanol amine, di-isopropyl amine, dibenzyl amine, imidazole, benzimidazole, and caffeine.

In another aspect, a method for making the compound with formula 3 is provided. The method includes steps of mixing a salt of a nitrogen-containing organic compound thereof with potassium ferricyanide (K₃Fe(CN)₆) in water and collecting crystals formed after a variable crystallization-induction time. Characteristically, the nitrogen-organic compound includes a labile hydrogen atom, as defined above. In a refinement, the salt of a nitrogen-containing organic compound is a salt (e.g., the hydrochloride) of an amine, an imine, an amide, or a nitrogen-containing polycyclic compound. In another refinement, the salt of a nitrogen-containing organic compound is a salt (e.g., the hydrochloride) of a primary amine, a secondary amine, a tertiary amine, imidazole, purine, pyridine, a catecholamine, or an amino acid. Therefore, the salt of a nitrogen-containing organic compound can be the salt of an amine selected from R¹NH₂,r R¹R²NH or R¹R²R³N where R¹, R², and R³ are C₁₋₁₀ alkyl. In a refinement, about 3 mole equivalents of the salt of a nitrogen-containing organic compound thereof are mixed with 1 mole of potassium ferricyanide. In some refinements, the molar ratio of the salt of a nitrogen-containing organic compound thereof to potassium ferricyanide is at least 1:1, 2:1, or 3:1, and at most 6:1, 5:1, 4:1, or 3:1.

In another aspect, a method for preparing an organic hydrogen ferrocyanide is provided. The method includes a step of reacting tri-potassium hydrogen ferrocyanide (K₃HFe(CN)₆) with a salt of a nitrogen-containing compound to form compound 2:

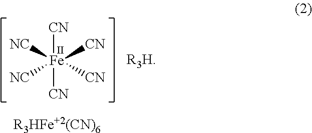

wherein R is a nitrogen-containing organic cation, and the oxidation state of iron is +2 (Fe⁺²). In a refinement, the salt of a nitrogen-containing compound is a hydrochloride salt RCl, where R is a nitrogen-containing organic cation of an amine, an imine, an amide, or a nitrogen-containing polycyclic compound. In a further refinement, the amine hydrochloride is selected from the group consisting of hydrochlorides of dopamine, histamine, octopamine, di-ethanol amine, di-isopropyl amine, dibenzyl amine, imidazole, benzimidazole, and caffeine. In another refinement, the amine salt is a salt of a primary amine, a secondary amine, or a tertiary amine.

In refinement, the tri-potassium hydrogen ferrocyanide is formed by reacting potassium ferricyanide with hydrazine or hydrazine hydrate.

In another aspect, a method for generating hydroxyl radicals. The method includes a step of reacting a compound of formula R₃FeH(CN)₆ with hydrogen peroxide to produce clean hydroxyl radicals.

In another aspect, a method for modifying R in R₄Fe(CN)₆ is provided. The method includes a step of reacting a compound of formula R₄Fe(CN)₆ with hydrogen peroxide to form a modified R substituent.

In another aspect, a method for using the compounds set forth above is provided. In one refinement, compounds having the formula R₃Fe(CN)₆ are applied as an oxidant in processes where the compounds are soluble in organic solvents. In another refinement, applying compounds having the formula R₄Fe(CN)₆ are applied as a reducing agent in processes where the compounds are soluble in organic solvents.

In another aspect, a method for using the compounds set forth above is provided. The method includes a step of applying a compound of formula R₄Fe(CN)₆ as a redox-based delivery agent of the ligand groups R attached thereof, the attached R groups having inherent properties as anticancer nitrogen mustards, adenosine receptors inhibitors and general modulators that are released upon activation by an oxidant agent. In a refinement, the oxidant agent is hydrogen peroxide or the hydroxyl radical inside the human body.

The following examples illustrate the various embodiments of the present invention. Those skilled in the art will recognize many variations that are within the spirit of the present invention and scope of the claims.

### Synthetic Methodology

Typically, the reactions are carried out at ambient temperatures and pressure. For example, the reaction can be carried out at a temperature from 20 to 30° C. (e.g. room temperature) and a pressure of about 0.8 to 1.2 atm. It should be appreciated that the hypochlorite salts used in each of the methods can be replaced with other hypohalite salts such as potassium hypoiodite.

### I. Salt Exchange

### General Method

### A. Organic Ferricyanides or Hexacyanoferrates III

### 1. Preparation of the Amine Hydrochloride:

The amine hydrochlorides are made by sequentially mixing in a beaker the pure amine with small portions of 6M hydrochloric acid until the amine forms a solution containing the amine hydrochloride as exemplified in FIG. 1a. Examples of a primary amine includes dopamine, histamine, and octopamine. Secondary amines include di-ethanol amine, di-isopropyl amine, and dibenzyl amine. Tertiary amines include imidazole, benzimidazole, and caffeine.

### 2. Preparation of the Organic Ferricyanide or Hexacyanoferrate III:

A solution of 1 mole of potassium ferricyanide in the minimum amount of water is mixed in a beaker with 3 moles of the amine hydrochloride previously prepared. The resulting solution is left standing until crystals of the organic ferricyanide forms. This standing period varies from a few minutes to several days. The crystals are filtered and dried and their purity and composition are evaluated preferentially by X-ray crystallography. This process corresponds to FIG. 1b.

### EXAMPLE

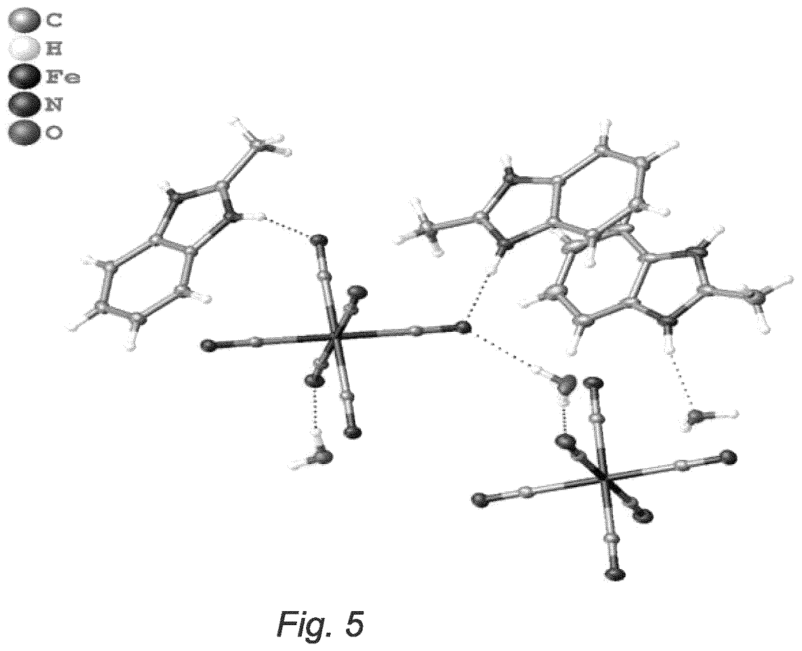

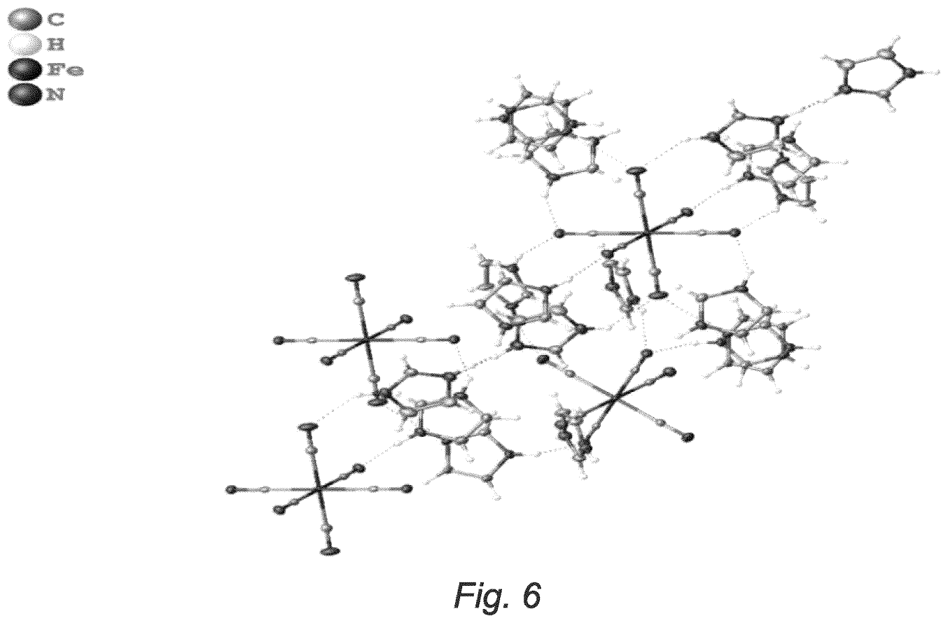

A 0.03 mole aqueous solution of 2-methyl benzimidazole hydrochloride, prepared by adding 5 ml of HCl 6M to 3.96 g of solid 2-methyl benzimidazole, is added with stirring to 0.01 mole (3.29 g) of potassium ferricyanide dissolved in 10 ml of water in a 100 ml beaker. After 15 min standing, crystallization occurs, and after 2 h the crystals are filtered through a sintered glass filter and air dried to produce 6.16 g (85% yield) of tris (2-methyl benzimidazole) ferricyanide as red-orange crystals whose structure was confirmed by X-ray crystallography and shown in FIG. 5 (data available).

### B. Organic Ferrocyanides or Hexacyanoferrates II

### 3. Preparation of the Amine Hydrochloride:

The amine hydrochlorides are made by sequentially mixing in a beaker the pure amine with small portions of 6M hydrochloric acid until the amine forms a solution containing the amine hydrochloride as exemplified in FIG. 1a.

### 4. Preparation of the Organic Ferrocyanide or Hexacyanoferrate II:

A solution of 1 mole of potassium ferricyanide in the minimum amount of water is mixed in a beaker with 4 moles of the amine hydrochloride previously prepared. The resulting solution is left standing until crystals of the organic ferrocyanide forms. This standing period varies from a few minutes to several days. The crystals are filtered and dried and their purity and composition are evaluated preferentially by X-ray crystallography. This process corresponds to FIG. 1c.

### Example 1

A 0.04 mole aqueous solution of imidazole hydrochloride, prepared by adding 6.7 ml of HCl 6M to 2.72 g of solid imidazole, is added with stirring to 0.01 mole (4.22 g) of potassium ferrocyanide dissolved in 10 ml of water in a 100 ml beaker. After 30 min standing, crystallization occurs, and after 4 h the crystals are filtered through a sintered glass filter and air dried to produce 5.20 g (75% yield) of tetra imidazole ferrocyanide as light-yellow crystals whose structure was confirmed by X-ray crystallography and shown in FIG. 6 (data available).

### Example 2

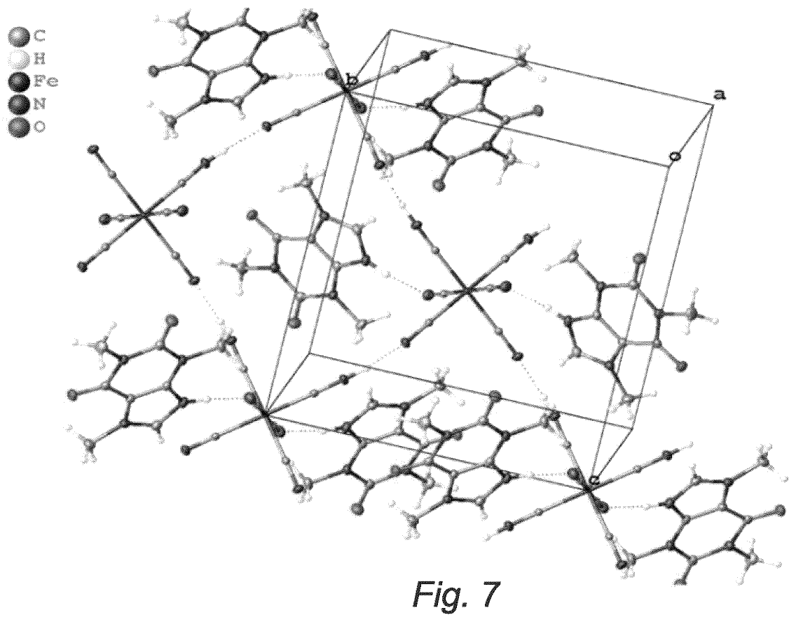

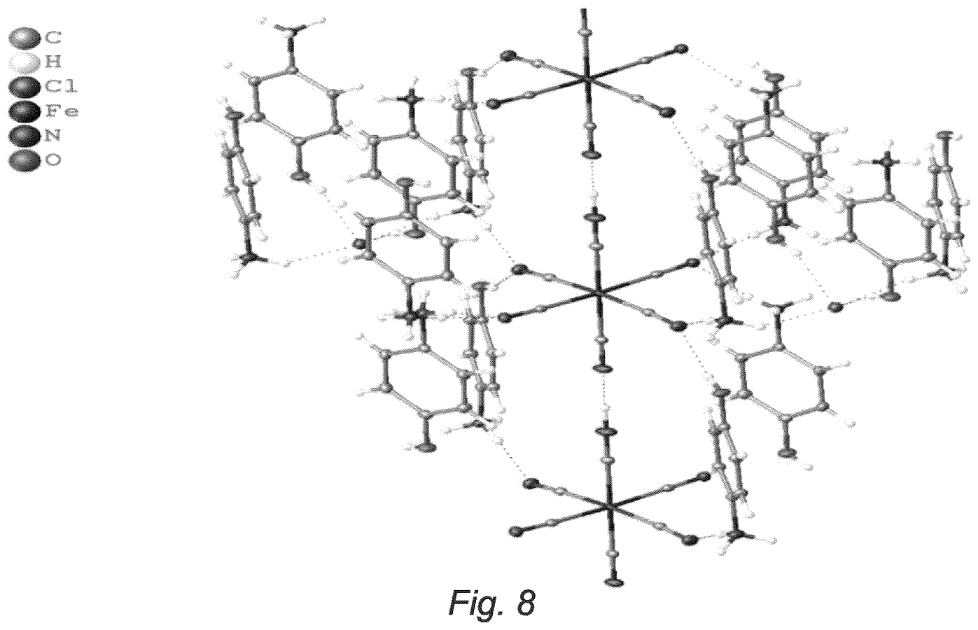

A 0.04 mole aqueous solution of caffeine hydrochloride, prepared by adding 6.7 ml of HCl 6M to 7.76 g of solid caffeine, is added with stirring to 0.01 mole (4.22 g) of potassium ferrocyanide dissolved in 10 ml of water in a 100 ml beaker. After 3 h standing, crystallization occurs, and after 12 h the crystals are filtered through a sintered glass filter and air dried to produce 7.43 g (62% yield) of tetra caffeine ferrocyanide as light-yellow crystals whose structure was confirmed by X-ray crystallography and shown in FIG. 7 (data available).

### Example 3

A 0.04 mole aqueous solution of 4-aminophenol hydrochloride, prepared by adding 6.7 ml of HCl 6M to 4.36 g of solid 4-aminophenol, is added with stirring to 0.01 mole (4.22 g) of potassium ferrocyanide dissolved in 10 ml of water in a 100 ml beaker. After 2 h standing, crystallization occurs, and after 12 h the crystals are filtered through a sintered glass filter and air dried to produce 6.52 g (76% yield) of tetra (4-aminophenol) ferrocyanide as grey-blue crystals whose structure was confirmed by X-ray crystallography and shown in FIG. 8 (data available).

### General Method for the Preparation of Organic Hydrogen Ferrocyanides

A solution of 1 mole of an organic ferricyanide or hexacyanoferrate III in water is mixed with 1 mole of hydrazine hydrate. Evolution of nitrogen gas is observed upon mixing and the solution is left standing until crystals are formed and the mixture is left to dry since the only by-product is nitrogen gas according to the equation in FIG. 2.

As a second method, a solution of 1 mole of tri-potassium hydrogen ferrocyanide in the minimum amount of water is mixed in a beaker with 3 moles of the amine hydrochloride previously prepared. The resulting solution is left standing until crystals of the organic hydrogen ferrocyanide forms. This standing period varies from a few minutes to several days. The crystals are filtered and dried and their purity and composition are evaluated preferentially by X-ray crystallography.

### 5. Preparation of Tris-Potassium Hydrogen Ferrocyanide

A solution of 1 mole of potassium ferricyanide in water is mixed with 1 mole of hydrazine hydrate. Evolution of nitrogen gas is observed upon mixing and the solution is left standing until crystals are formed and the mixture is left to dry since the only by-product is nitrogen gas.

II. General Reaction of Organic Hydrogen Ferrocyanides with Hydrogen Peroxide and Detection of Hydroxyl Radicals with 2-Aminophenol

A solution of an organic hydrogen ferrocyanide in water in a beaker is covered with 1 in. layer of a 5% solution of 2-aminophenol in ethyl acetate. Hydrogen peroxide 50% in water is added dropwise to the biphasic mixture where it moves directly to the bottom aqueous layer to react with the hydrogen ferrocyanide. The hydroxyl radicals produced travel upwards towards the non-polar phase of ethyl acetate and react with the light yellow-colored 2-aminophenol to produce the stable bright red 2-imino quinone dimer. The two layers are separated using a separatory funnel and concentrated separately to produce red crystals of the 2-imino quinone dimer for the organic phase and the organic ferricyanide or hexacyanoferrate III crystals from the water layer as shown in FIG. 3b.

III. General Reaction of Organic Ferrocyanides with Hydrogen Peroxide And Detection of Products

To a solution of the organic ferrocyanide in water, or water/methanol mixture of variable composition based on the solubility of the ferrocyanide, is added dropwise 50% hydrogen peroxide until no more evolution of oxygen is observed. The solution is concentrated to dryness and then extracted with pure ethyl acetate or with a 50:50 mixture by volume of ethyl acetate/ethanol to remove the modified ligand. The solid remaining after extraction corresponds to the organic ferricyanide.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A compound having formula 1: 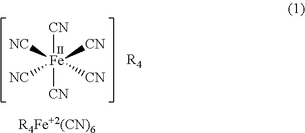
wherein R is a nitrogen-containing organic cation, and the oxidation state of iron is +2 (Fe⁺²).

2. The compound of claim 1, wherein R is a nitrogen-containing organic cation of an amine, an imine, an amide, or a nitrogen-containing polycyclic compound.

3. The compound of claim 1, wherein R is a nitrogen-containing organic cation of a primary amine, a secondary amine, a tertiary amine, imidazole, purine, pyridine, catecholamine, or amino acid.

4. A method for making the compound of claim 1 comprising:
mixing a salt of a nitrogen-containing organic compound with potassium ferrocyanide in water; and collecting crystals formed after a variable crystallization-induction time.

5. The compound of claim 1, wherein the salt of a nitrogen-containing organic compound is a salt of an amine, an imine, an amide, or a nitrogen-containing polycyclic compound.

6. The method of claim 4, wherein the salt of a nitrogen-containing organic compound is a salt of a primary amine, a secondary amine, a tertiary amine, imidazole, purine, pyridine, a catecholamine, or an amino acid.

7. The method of claim 4, wherein about 4 mole equivalents of the salt of a nitrogen-containing organic compound is mixed with 1 mole of potassium ferricyanide.

8. A compound having formula 2: 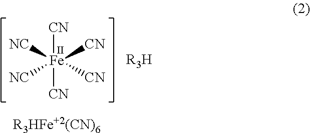
wherein R is a nitrogen-containing organic cation, and the oxidation state of iron is +2 (Fe⁺²).

9. The compound of claim 8, wherein R is a nitrogen-containing organic cation of an amine, an imine, an amide, or a nitrogen-containing polycyclic compound.

10. The compound of claim 8, wherein R is a nitrogen-containing organic cation of a primary amine, a secondary amine, a tertiary amine, imidazole, purine, pyridine, catecholamine, or amino acid.

11. A method for making the compound of claim 6 comprising:
mixing a compound having formula R₃Fe(CN)₆ in water with hydrazine and collecting crystals formed after a variable crystallization-induction time.

12. A method for making the compound of claim 6 comprising:
mixing a salt of a nitrogen-containing organic compound with tri-potassium hydrogen ferrocyanide in water; and collecting crystals formed after a variable crystallization-induction time.

13. A method for making the compound tri-potassium hydrogen ferrocyanide comprising:
mixing a compound having formula K₃Fe(CN)₆ in water with hydrazine and collecting crystals formed after a variable crystallization-induction time.

14. The method of claim 8, wherein about 1 mole equivalent of the compound having formula R₃Fe(CN)₆ is mixed with 1 mole of hydrazine.

15. A compound having formula 3: 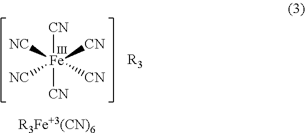
wherein R is a nitrogen-containing organic cation, and the oxidation state of iron is +3 (Fe⁺³).

16. The compound of claim 15, wherein R is a nitrogen-containing organic cation of an amine, an imine, an amide, or a nitrogen-containing polycyclic compound.

17. The compound of claim 15, wherein R is a nitrogen-containing organic cation of a primary amine, a secondary amine, a tertiary amine, imidazole, purine, pyridine, catecholamine, or amino acid.

18. A method for making the compound of claim 15 comprising:
mixing a salt of a nitrogen-containing organic compound thereof with potassium ferricyanide, K₃Fe(CN)₆ in water; and collecting crystals formed after a variable crystallization-induction time.

19. The method of claim 18, wherein the salt of a nitrogen-containing organic compound is a salt of an amine, an imine, an amide, or a nitrogen-containing polycyclic compound.

20. The method of claim 18, wherein the salt of a nitrogen-containing organic compound is a salt of a primary amine, a secondary amine, a tertiary amine, imidazole, purine, pyridine, a catecholamine, or an amino acid.

21. The method of claim 18, wherein about 3 mole equivalents of the salt of a nitrogen-containing organic compound thereof are mixed with 1 mole of potassium ferricyanide.

22. A method for generating hydroxyl radicals comprising:
reacting a compound of formula R₃FeH(CN)₆ with hydrogen peroxide to produce clean hydroxyl radicals.

23. A method comprising:
reacting a compound of formula R₄Fe(CN)₆ with hydrogen peroxide to form a modified R substituent.

24. A method comprising:
applying compounds having formula R₃Fe(CN)₆ as an oxidant in processes where the compounds are soluble in organic solvents.

25. A method comprising:
applying compounds having formula R₄Fe(CN)₆ as a reducing agent in processes where the compounds are soluble in organic solvents.

26. A method comprising:
applying a compound of formula R₄Fe(CN)₆ as a redox-based delivery agent of ligand groups R attached thereto, the attached R groups having inherent properties as anticancer nitrogen mustards, adenosine receptors inhibitors, and general modulators that are released upon activation by an oxidant agent.

27. The method of claim 26, wherein the oxidant agent is hydrogen peroxide or hydroxyl radical inside a human body.

28. A method for preparing an organic hydrogen ferrocyanide comprising:
reacting tri-potassium hydrogen ferrocyanide (K₃HFe(CN)₆) with a salt of a nitrogen-containing compound to form compound 2: 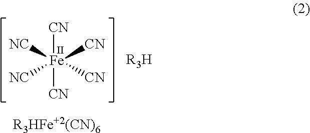
wherein R is a nitrogen-containing organic cation, and the oxidation state of iron is +2 (Fe⁺²).

29. The method of claim 28, wherein the tri-potassium hydrogen ferrocyanide is formed by reacting potassium ferricyanide with hydrazine or hydrazine hydrate.

30. The method of claim 28, wherein the salt of a nitrogen-containing compound is a hydrochloride.

31. The method of claim 28, wherein the amine hydrochloride has formula R¹ₓNH_{y}Cl where x=1 and y=3 for primary amines, x=2 and y=2 for secondary amines, and x=3 for y=1 for tertiary amines.

32. The method of claim 28 wherein the amine hydrochloride is selected from the group consisting of hydrochlorides of dopamine, histamine, octopamine, di-ethanol amine, di-isopropyl amine, dibenzyl amine, imidazole, benzimidazole, and caffeine.
